(19) United States
(12) Patent Application Publication
(10) Pub. No.: US 2022/0075201 A1
(43) Pub. Date: Mar. 10, 2022

(54) LENS DRIVE DEVICE

(71) Applicant: FUJIFILM Corporation, Tokyo (JP)

(72) Inventor: Yasuhiro MORI, Saitama (JP)

(73) Assignee: FUJIFILM Corporation, Tokyo (JP)

(21) Appl. No.: 17/455,269

(22) Filed: Nov. 17, 2021

Related U.S. Application Data
(63) Continuation of application No. PCT/JP2020/019249, filed on May 14, 2020.

(30) Foreign Application Priority Data
May 21, 2019 (JP) 2019-095095

(51) Int. Cl. G02B 27/64; G02B 7/02; G03B 5/00; H01F 7/08

(52) U.S. Cl. CPC G02B 27/646; G02B 7/02; G03B 2205/0069; H01F 7/081; G03B 2205/0007; G03B 5/00

(57) ABSTRACT

A lens drive device includes a holder that holds a lens for shake correction from an outer peripheral side of the lens, and a plurality of coil motors that are disposed along a circumferential direction of the lens with respect to the holder. Each of the coil motors includes a magnet, a yoke that forms magnetic flux along with the magnet, and a coil that has an air-core portion. The coil is fixed to the holder. The yoke is inserted into the air-core portion. The coil is configured to move the holder in a lens radial direction by generating thrust from an applied current and magnetic flux. The yoke has a dent where a side surface in the yoke facing an outer peripheral surface of the lens is formed in a shape recessed in a direction of being separated from an optical axis of the lens.

### CROSS-REFERENCE TO RELATED APPLICATIONS

This application is a continuation application of International Application No. PCT/JP2020/019249, filed May 14, 2020, the disclosure of which is incorporated herein by reference in its entirety. Further, this application claims priority under 35 USC 119 from Japanese Patent Application No. 2019-095095 filed May 21, 2019, the disclosure of which is incorporated by reference herein.

### BACKGROUND

### 1. Technical Field

A technique of the present disclosure relates to a lens drive device.

### 2. Related Art

JP2018-180285A discloses a VCM drive device comprising a movable section that has an optical element and a coil having an opening portion, a surface of the opening portion being disposed in parallel with an optical axis of the optical element, and a fixed section having a first magnet and a second magnet disposed to face respective long sides of the coil, a central yoke disposed between the first magnet and the second magnet, a part of the central yoke being positioned in the opening portion of the coil, and an outer yoke configured to supply magnetic flux from the first magnet and the second magnet to the central yoke. The outer yoke includes a first outer yoke positioned on an opposite side of the first magnet from the central yoke in an optical axis direction, and a second outer yoke positioned on an opposite side of the second magnet from the central yoke in the optical axis direction. An area of each of the first outer yoke and the second outer yoke overlapping the coil is smaller than an area overlapping the first magnet and the second magnet in the optical axis direction.

JP3294677B discloses an anti-vibration system that makes an optical axis eccentric with a correction optical unit to correct shake applied to optical equipment. The anti-vibration system has a micro vibration drive unit that causes micro vibration of the correction optical unit at a predetermined frequency higher than a frequency of shake, a shake detection unit that detects Coriolis force generated by an angular velocity of shake and movement of mass of the correction optical unit in a micro vibration state as displacement of the correction optical unit due to shake, and an optical axis eccentric drive unit that makes the optical axis eccentric to the correction optical unit based on an output of the shake detection unit.

### SUMMARY

An embodiment according to the technique of the present disclosure provides a lens drive device capable of making a lens for shake correction approach a yoke compared to a case in which a side surface in a yoke of a voice coil motor facing an outer peripheral surface of a lens for shake correction is an unrecessed flat surface.

A first aspect according to the technique of the present disclosure is a lens drive device comprising a holder that holds a lens for shake correction from an outer peripheral side of the lens, and a plurality of coil motors disposed along a circumferential direction of the lens with respect to the holder. Each of the coil motors includes a magnet, a yoke that forms magnetic flux along with the magnet, and a coil that has an air-core portion. The coil is fixed to the holder, the yoke is inserted into the air-core portion, and the coil is configured to move the holder in a lens radial direction by generating thrust from an applied current and the magnetic flux. The yoke has a recess in which a side surface of the yoke facing an outer peripheral surface of the lens is formed in a shape recessed in a direction of being separated from an optical axis of the lens.

A second aspect according to the technique of the present disclosure is the lens drive device according to the first aspect, in which a protruding end portion of the recess protrudes from the coil toward the outer peripheral surface.

A third aspect according to the technique of the present disclosure is the lens drive device according to the second aspect, in which the protruding end portion protrudes from the coil toward the outer peripheral surface at an initial position of the coil.

A fourth aspect according to the technique of the present disclosure is the lens drive device according to the second aspect or the third aspect, in which the protruding end portion protrudes from the coil toward the outer peripheral surface within a movable range of the coil.

A fifth aspect according to the technique of the present disclosure is the lens drive device according to any one of the second aspect to the fourth aspect, in which the protruding end portion is both end portions of the recess in a tangential direction of an outer periphery of the lens.

A sixth aspect according to the technique of the present disclosure is the lens drive device according to any one of the first aspect to the fifth aspect, in which the recess is recessed along an outer peripheral shape of the holder.

A seventh aspect according to the technique of the present disclosure is the lens drive device according to the sixth aspect, in which the outer peripheral shape is a ring shape or an arc shape, and the recess is recessed in an arc shape.

An eighth aspect according to the technique of the present disclosure is the lens drive device according to any one of the first aspect to the seventh aspect, in which the magnet has a first magnet that is provided on a first direction side of the yoke along the optical axis, and a second magnet that is provided on a second direction side of the yoke opposite to the first direction, and the first magnet and the second magnet are disposed such that identical magnetic poles face each other while sandwiching the yoke.

A ninth aspect according to the technique of the present disclosure is the lens drive device according to the eighth aspect, further comprising a first direction-side yoke that is provided on the first direction side of the first magnet, and a second direction-side yoke that is provided on the second direction side of the second magnet, in which an end surface of the first direction-side yoke on the lens side and an end surface of the second direction-side yoke on the lens side are positioned on a side closer to the optical axis than an end point on the lens side in a movable range of the coil.

A tenth aspect according to the technique of the present disclosure is the lens drive device according to any one of the first aspect to the ninth aspect, in which the coil is formed by being bent along an outer peripheral shape of the holder.

An eleventh aspect according to the technique of the present disclosure is the lens drive device according to the tenth aspect, in which at least one end portion of both end portions of the coil in a tangential direction of an outer periphery of the lens is formed by being bent along the outer peripheral shape of the holder.

A twelfth aspect according to the technique of the present disclosure is the lens drive device according to the eleventh aspect, in which at least one end portion of both end portions of the coil is formed by being bent in a direction approaching the optical axis.

A thirteenth aspect according to the technique of the present disclosure is the lens drive device according to any one of the first aspect to the twelfth aspect, in which the magnet and the yoke are fixed to a housing, the coil is fixed to the holder, and the holder is movably supported by the housing.

A fourteenth aspect according to the technique of the present disclosure is the lens drive device according to any one of the first aspect to the thirteenth aspect, in which the coil has a receiving recess that receives an outer peripheral portion of the holder.

### BRIEF DESCRIPTION OF THE DRAWINGS

Exemplary embodiments of the technology of the disclosure will be described in detail based on the following figures, wherein:

FIG. 1 is a perspective view of a lens drive device according to a first embodiment.

FIG. 2 is a plan view of the lens drive device according to the first embodiment as viewed from a direction along an optical axis;

FIG. 3 is a sectional view of the lens drive device shown in FIG. 2 taken along the line A-A;

FIG. 4 is a side view of the lens drive device according to the first embodiment;

FIG. 5 is a sectional view of the lens drive device shown in FIG. 4 taken along the line B-B;

FIG. 6 is a partial schematic view showing change in interval between a holding frame and a yoke of the lens drive device shown in FIG. 5;

FIG. 7 is a side view of a lens drive device according to a second embodiment;

FIG. 8 is a sectional view of the lens drive device shown in FIG. 7 taken along the line C-C;

FIG. 9 is a partial schematic view showing change in interval between a holding frame and a yoke of the lens drive device shown in FIG. 8;

FIG. 10 is a side view of a lens drive device according to a third embodiment;

FIG. 11 is a sectional view of the lens drive device shown in FIG. 10 taken along the line D-D;

FIG. 12 is a partial schematic view showing change in interval between a holding frame and a yoke of the lens drive device shown in FIG. 11;

FIG. 13 is a sectional view showing a case where a coil according to the first embodiment shown in FIG. 5 is substituted with a coil according to a fourth embodiment;

FIG. 14 is a perspective view of a coil according to a fifth embodiment; and

FIG. 15 is a longitudinal sectional view of the coil and a holding frame according to the fifth embodiment.

### DETAILED DESCRIPTION

### First Embodiment

An imaging device, such as a digital camera, is provided with a shake correction device that corrects shake due to camera shake or the like. As a method of correcting shake, an optical correction method and an electronic correction method are known. The optical correction method is a method in which a correction lens for shake correction is disposed in an optical system and the correction lens is moved in a direction counteracting shake to correct shake.

Since a lens drive device that moves the correction lens in the optical correction method is incorporated in an optical system of an imaging device, it is desirable that the lens drive device is as small in size as possible. On the other hand, the lens drive device is required to perform correction of shake (hereinafter, referred to as “shake correction”) as fast as possible and accurately. To perform shake correction fast, there is a need to make thrust for driving the lens drive device large, and to perform shake correction accurately, there is a need to control the position of the correction lens with excellent accuracy.

As an actuator that drives the correction lens, for example, a voice coil motor that is small in size and can obtain large thrust is used. The thrust of the voice coil motor is greater as a coil is closer to a magnet and is smaller as the coil is farther from the magnet, and thus, it is difficult to maintain thrust constant. A reason for change in thrust depending on a positional relationship between the coil and the magnet is that a degree of overlapping of magnetic flux generated from the coil and magnetic flux generated from the magnet changes depending on the positional relationship between the coil and the magnet.

The change in thrust of the voice coil motor depending on the positional relationship between the coil and the magnet, in other words, the position of the correction lens causes difficulty in feedback control for driving the correction lens to perform shake correction. To suppress the change in thrust depending on the position of the correction lens, there is a need to suppress change in the degree of overlapping of the magnetic flux of the coil and the magnetic flux of the magnet depending on the position of the correction lens. To this end, there is a need to suppress change in range in which a yoke and a coil overlap in a direction along an optical axis of the correction lens.

Hereinafter, an example of an embodiment of the technique of the present disclosure will be described referring to the drawings. In a case where a concept of up, down, right, and light directions is used in description of members or configurations in the drawings, the concept simply means up, down, right, and left directions in the drawings unless particularly described, and does not mean absolute directions. In the following description, a meaning of “perpendicular” includes a meaning of substantially perpendicular including an allowable error in design and manufacturing in addition to a meaning of completely perpendicular. Furthermore, in the following description, a meaning of a “right angle” includes a meaning of a substantially right angle including an allowable error in design and manufacturing in addition to a completely coincident right angle. In the following description, a meaning of “parallel” includes a meaning of substantially parallel including an allowable error in design and manufacturing in addition to a meaning of completely coincident parallel. In the following description, a meaning of “coincident” includes a meaning of substantially coincident including an allowable error in design and manufacturing in addition to a meaning of completely coincident. In the following description, a meaning of “identical” includes a meaning of substantially identical including an allowable error in design and manufacturing in addition to a meaning of completely identical.

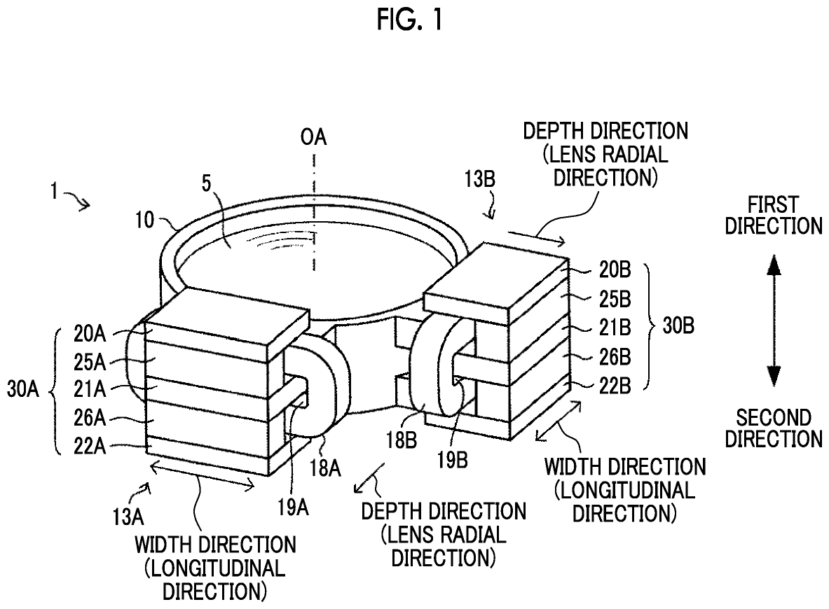

A lens drive device 1 according to a first embodiment is disposed in an optical system of an imaging device for use. The lens drive device 1 is not limited to the optical system of the imaging device, and is applicable to, for example, an optical system of a distance measurement device. As shown in FIG. 1 as an example, a first direction and a second direction are defined for the lens drive device 1. The “first direction” indicates one direction of an optical axis OA (in an example shown in FIG. 1, a direction toward an upper side of the drawing along the optical axis OA). The “second direction” indicates the other direction of the optical axis OA (in the example shown in FIG. 1, a direction toward a lower side of the drawing along the optical axis OA). That is, the second direction means an opposite direction to the first direction.

The lens drive device 1 has a holding frame 10, a first voice coil motor 13A, and a second voice coil motor 13B. Hereinafter, the voice coil motor is also referred to as a “VCM”. The first VCM 13A and the second VCM 13B are an example of “a plurality of coil motors” according to the technique of the present disclosure.

The holding frame 10 holds a lens 5 for shake correction (hereinafter, simply referred to as a “lens 5”). Specifically, the holding frame 10 holds the lens 5 from an outer peripheral side of the lens 5. In the example shown in FIG. 1, the entire outer periphery of the lens 5 is held by the holding frame 10. The holding frame 10 does not necessarily hold the entire outer periphery of the lens 5, and may partially hold the outer periphery of the lens 5. The holding frame 10 is an example of a “holder” according to the technique of the present disclosure.

In a case where the lens 5 is at a lens initial position, the optical axis OA of the lens 5 coincides with an optical axis of the optical system in which the lens drive device 1 is disposed. The lens initial position indicates a position of the lens 5 in a state in which movement control for shake correction is not performed. In the following description of the lens drive device 1, unless particularly described, a configuration in a case where the lens 5 is at the lens initial position will be described.

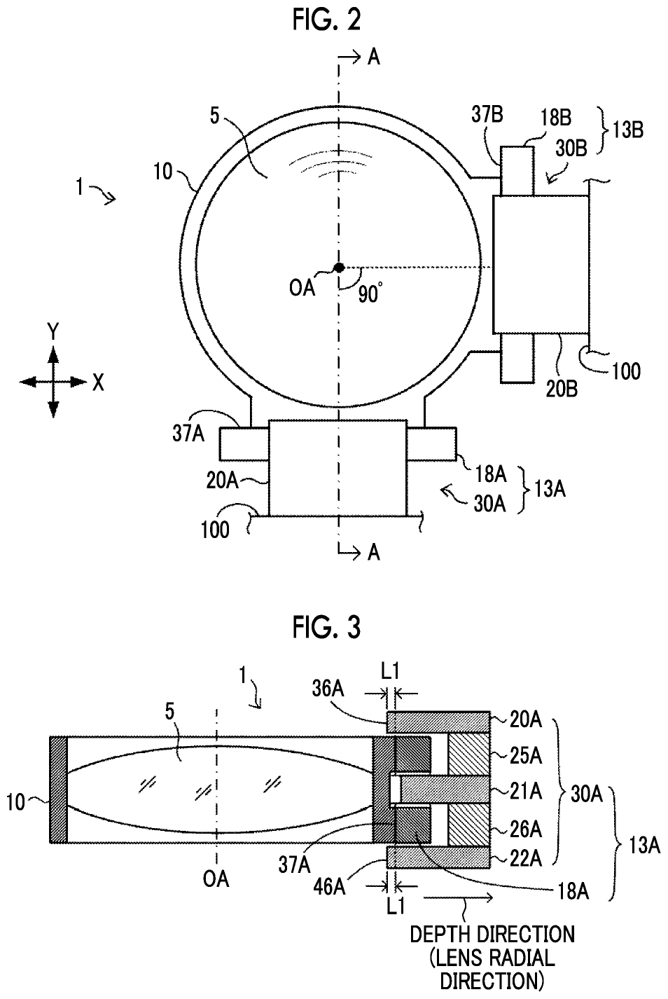

The first VCM 13A and the second VCM 13B are disposed along a circumferential direction of the lens 5 with respect to the holding frame 10. The holding frame 10 is supported to be movable in a direction intersecting the optical axis of the optical system by a housing 100 (see FIG. 2) that holds the optical system in which the lens drive device 1 is disposed. Here, as an example of the direction intersecting the optical axis of the optical system, a direction perpendicular to the optical axis is employed. A known method can be used on a structure for movably supporting the lens drive device 1 by the housing 100, and thus, detailed description will not be repeated in the specification.

Next, a detailed configuration of the first VCM 13A will be described. As shown in FIG. 1 as an example, the first VCM 13A includes a first VCM magnet section 30A and a first coil 18A. The first VCM magnet section 30A is fixed to the housing 100. The first coil 18A is fixed to the holding frame 10. The first coil 18A is an example of a “coil” according to the technique of the present disclosure.

The first VCM magnet section 30A comprises a first upper yoke 20A, a first middle yoke 21A, a first lower yoke 22A, a first upper magnet 25A, and a first lower magnet 26A. The first upper yoke 20A, the first middle yoke 21A, and the first lower yoke 22A are an example of a “yoke” according to the technique of the present disclosure. The first upper yoke 20A is an example of a “first direction-side yoke” according to the technique of the present disclosure. The first lower yoke 22A is an example of a “second direction-side yoke” according to the technique of the present disclosure. The first upper magnet 25A and the first lower magnet 26A are an example of a “magnet” according to the technique of the present disclosure. The first upper magnet 25A is an example of a “first magnet” according to the technique of the present disclosure. The first lower magnet 26A is an example of a “second magnet” according to the technique of the present disclosure.

The first upper yoke 20A, the first middle yoke 21A, and the first lower yoke 22A are disposed in order from the first direction side to the second direction side along the optical axis OA. The first upper magnet 25A is provided on the first direction side, and the first lower magnet 26A is provided on the second direction side. The first upper yoke 20A is provided on the first direction side of the first upper magnet 25A, and the first lower yoke 22A is provided on the second direction side of the first lower magnet 26A.

That is, the first upper magnet 25A is interposed between the first upper yoke 20A and the first middle yoke 21A, and the first lower magnet 26A is interposed between the first middle yoke 21A and the first lower yoke 22A. In other words, the first upper yoke 20A, the first upper magnet 25A, the first middle yoke 21A, the first lower magnet 26A, and the first lower yoke 22A are laminated in order from the first direction side to the second direction side along the optical axis OA.

All the first upper yoke 20A, the first lower yoke 22A, the first upper magnet 25A, and the first lower magnet 26A are formed in a rectangular parallelepiped shape. The first upper yoke 20A and the first lower yoke 22A are formed to have an identical shape and an identical size. The first middle yoke 21A is thicker than the first upper yoke 20A and the first lower yoke 22A (also see FIG. 3).

In regards to the lengths of the first middle yoke 21A, the first upper yoke 20A, and the first lower yoke 22A in a width direction (longitudinal direction) in a case where the first VCM magnet section 30A is viewed from the center side of the lens 5, the first middle yoke 21A, the first upper yoke 20A, and the first lower yoke 22A are identical.

The first upper yoke 20A is disposed in such a posture that one side surface (in an example shown in FIG. 3, an end surface 36A) extending in the longitudinal direction among side surfaces of the first upper yoke 20A is directed toward an outer peripheral surface of the lens 5 and a thickness direction of the first upper yoke 20A coincides with the direction of the optical axis OA. The first middle yoke 21A and the first lower yoke 22A are disposed in a posture identical to the first upper yoke 20A.

A side surface most separated from the outer peripheral surface of the lens 5 among the side surfaces of the first upper yoke 20A, a side surface most separated from the outer peripheral surface of the lens 5 among side surfaces of the first middle yoke 21A, and a side surface most separated from the outer peripheral surface of the lens 5 among side surfaces of the first lower yoke 22A have a relationship of being parallel along the optical axis OA and flush with one another.

In regards to lengths of the first upper magnet 25A and the first lower magnet 26A in a depth direction in a case where the first VCM magnet section 30A is viewed from the center side of the lens 5, the first upper magnet 25A and the first lower magnet 26A are identical (also see FIG. 3). Lengths of the first upper magnet 25A and the first lower magnet 26A in the width direction in a case where the first VCM magnet section 30A is viewed from the center side of the lens 5 are also identical.

The lengths of the first upper magnet 25A and the first lower magnet 26A in the depth direction in a case where the first VCM magnet section 30A is viewed from the center side of the lens 5 are shorter than a length of the first middle yoke 21A in the depth direction in a case where the first VCM magnet section 30A is viewed from the center side of the lens 5 (also see FIG. 3).

A side surface most separated from the outer peripheral surface of the lens 5 among side surfaces of the first upper magnet 25A and a side surface most separated from the outer peripheral surface of the lens 5 among side surfaces of the first lower magnet 26A have a relationship of being parallel along the optical axis OA and flush with each other (also see FIG. 3). The side surface most separated from the outer peripheral surface of the lens 5 among the side surfaces of the first upper magnet 25A and the side surface most separated from the outer peripheral surface of the lens 5 among the side surfaces of the first lower magnet 26A have a relationship of being flush with the side surface most separated from the outer peripheral surface of the lens 5 among the side surfaces of the first upper yoke 20A, the side surface most separated from the outer peripheral surface of the lens 5 among the side surfaces of the first middle yoke 21A, and the side surface most separated from the outer peripheral surface of the lens 5 among the side surfaces of the first lower yoke 22A (also see FIG. 3).

The first upper yoke 20A, the first middle yoke 21A, the first lower yoke 22A, the first upper magnet 25A, and the first lower magnet 26A are disposed in this way, whereby a space where the first coil 18A can be disposed is formed on the outer peripheral surface side of the lens 5 with respect to the first upper magnet 25A between the first upper yoke 20A and the first middle yoke 21A. A space where the first coil 18A can be disposed is also formed on the outer peripheral surface side of the lens 5 with respect to the first lower magnet 26A between the first middle yoke 21A and the first lower yoke 22A.

The first upper yoke 20A, the first middle yoke 21A, and the first lower yoke 22A is formed a magnetic substance and form magnetic flux along with the first upper magnet 25A and the first lower magnet 26A.

The first upper magnet 25A and the first lower magnet 26A are disposed such that identical magnetic poles face each other while sandwiching the first middle yoke 21A. That is, a magnetic pole on a side of the first upper magnet 25A in contact with the first middle yoke 21A and a magnetic pole of the first lower magnet 26A in contact with the first middle yoke 21A are identical.

As shown in FIG. 1 as an example, the first coil 18A has an air-core portion 19A. The first coil 18A is disposed such that the air-core portion 19A is present in a direction perpendicular to the optical axis OA and the longitudinal direction coincides with a tangential direction of the outer periphery of the lens 5. The first coil 18A is disposed between the first upper yoke 20A and the first lower yoke 22A in a state in which the first middle yoke 21A is inserted into the air-core portion 19A.

Next, a detailed configuration of the second VCM 13B will be described. As shown in FIG. 1 as an example, the second VCM 13B includes a second VCM magnet section 30B and a second coil 18B. The second VCM magnet section 30B is fixed to the housing 100. The second coil 18B is fixed to the holding frame 10. The second coil 18B is an example of a “coil” according to the technique of the present disclosure.

The second VCM magnet section 30B comprises a second upper yoke 20B, a second middle yoke 21B, a second lower yoke 22B, a second upper magnet 25B, and a second lower magnet 26B. The second upper yoke 20B, the second middle yoke 21B, and the second lower yoke 22B are an example of a “yoke” according to the technique of the present disclosure. The second upper yoke 20B is an example of a “first direction-side yoke” according to the technique of the present disclosure. The second lower yoke 22B is an example of a “second direction-side yoke” according to the technique of the present disclosure. The second upper magnet 25B and the second lower magnet 26B are an example of a “magnet” according to the technique of the present disclosure. The second upper magnet 25B is an example of a “first magnet” according to the technique of the present disclosure. The second lower magnet 26B is an example of a “second magnet” according to the technique of the present disclosure.

The second upper yoke 20B, the second middle yoke 21B, and the second lower yoke 22B are disposed in order from the first direction side to the second direction side along the optical axis OA. The second upper magnet 25B is provided on the first direction side, and the second lower magnet 26B is provided on the second direction side. The second upper yoke 20B is provided on the first direction side of the second upper magnet 25B, and the second lower yoke 22B is provided on the second direction side of the second lower magnet 26B.

That is, the second upper magnet 25B is interposed between the second upper yoke 20B and the second middle yoke 21B, and the second lower magnet 26B is interposed between the second middle yoke 21B and the second lower yoke 22B. In other words, the second upper yoke 20B, the second upper magnet 25B, the second middle yoke 21B, the second lower magnet 26B, and the second lower yoke 22B are laminated in order from the first direction side to the second direction side along the optical axis OA.

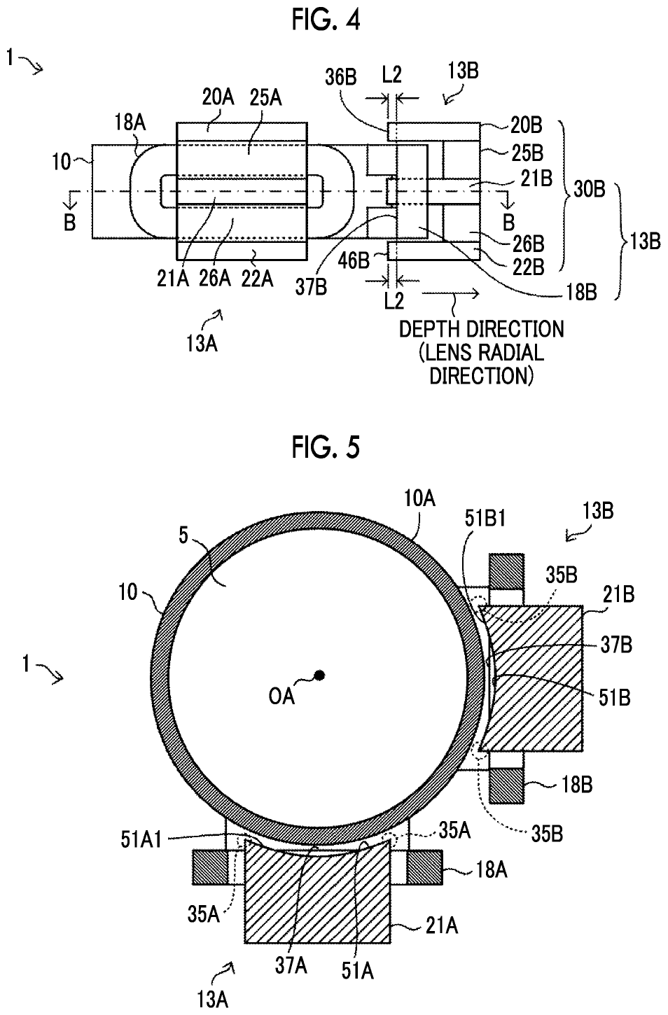

All the second upper yoke 20B, the second lower yoke 22B, the second upper magnet 25B, and the second lower magnet 26B are formed in a rectangular parallelepiped shape. The second upper yoke 20B and the second lower yoke 22B are formed to have an identical shape and an identical size. The second middle yoke 21B is thicker than the second upper yoke 20B and the second lower yoke 22B (also see FIG. 4).

In regards to lengths of the second middle yoke 21B, the second upper yoke 20B, and the second lower yoke 22B in a width direction (longitudinal direction) in a case where the second VCM magnet section 30B is viewed from the center side of the lens 5, the second middle yoke 21B, the second upper yoke 20B, and the second lower yoke 22B are identical.

The second upper yoke 20B is disposed in such a posture that one surface (in an example shown in FIG. 4, an end surface 36B) extending in the longitudinal direction among side surfaces of the second upper yoke 20B is directed toward the outer peripheral surface of the lens 5 and a thickness direction of the second upper yoke 20B coincides with the direction of the optical axis OA. The second middle yoke 21B and the second lower yoke 22B are also disposed in a posture identical to the second upper yoke 20B.

A side surface most separated from the outer peripheral surface of the lens 5 among the side surfaces of the second upper yoke 20B, a side surface most separated from the outer peripheral surface of the lens 5 among side surfaces of the second middle yoke 21B, and a side surface most separated from the outer peripheral surface of the lens 5 among side surfaces of the second lower yoke 22B have a relationship of being parallel along the optical axis OA and flush with one another (also see FIG. 4).

In regards to lengths of the second upper magnet 25B and the second lower magnet 26B in a depth direction in a case where the second VCM magnet section 30B is viewed from the center side of the lens 5, the second upper magnet 25B and the second lower magnet 26B are identical (also see FIG. 4). Lengths of the second upper magnet 25B and the second lower magnet 26B in the width direction in a case where the second VCM magnet section 30B is viewed from the center side of the lens 5 are also identical.

The lengths of the second upper magnet 25B and the second lower magnet 26B in the depth direction in a case where the second VCM magnet section 30B is viewed from the center side of the lens 5 are shorter than the lengths of a length of the second middle yoke 21B in the depth direction in a case where the second VCM magnet section 30B is viewed from the center side of the lens 5 (also see FIG. 4).

A side surface most separated from the outer peripheral surface of the lens 5 among the side surfaces of the second upper magnet 25B and a side surface most separated from the outer peripheral surface of the lens 5 among the side surfaces of the second lower magnet 26B have a relationship of being parallel along the optical axis OA and flush with each other (also see FIG. 4). The side surface most separated from the outer peripheral surface of the lens 5 among the side surfaces of the second upper magnet 25B and the side surface most separated from the outer peripheral surface of the lens 5 among the side surfaces of the second lower magnet 26B have a relationship of being flush with the side surface most separated from the outer peripheral surface of the lens 5 among the side surfaces of the second upper yoke 20B, the side surface most separated from the outer peripheral surface of the lens 5 among the side surfaces of the second middle yoke 21B, and the side surface most separated from the outer peripheral surface of the lens 5 among the side surfaces of the second lower yoke 22B (also see FIG. 4).

The second upper yoke 20B, the second middle yoke 21B, the second lower yoke 22B, the second upper magnet 25B, and the second lower magnet 26B are disposed in this way, whereby a space where the second coil 18B can be disposed is formed on the outer peripheral surface side of the lens 5 with respect to the second upper magnet 25B between the second upper yoke 20B and the second middle yoke 21B. A space where the second coil 18B can be disposed is also formed on the outer peripheral surface side of the lens 5 with respect to the second lower magnet 26B between the second middle yoke 21B and the second lower yoke 22B.

The second upper yoke 20B, the second middle yoke 21B, and the second lower yoke 22B is formed of a magnetic substance and form magnetic flux along with the second upper magnet 25B and the second lower magnet 26B.

The second upper magnet 25B and the second lower magnet 26B are disposed such that identical magnetic poles face each other while sandwiching the second middle yoke 21B. That is, a magnetic pole of the second upper magnet 25B in contact with the second middle yoke 21B and a magnetic pole of the second lower magnet 26B in contact with the second middle yoke 21B are identical.

As shown in FIG. 1 as an example, the second coil 18B has an air-core portion 19B. The second coil 18B is disposed such that the air-core portion 19B is present in a direction perpendicular to the optical axis OA and the longitudinal direction coincides with the tangential direction of the outer periphery of the lens 5. The second coil 18B is disposed between the second upper yoke 20B and the second lower yoke 22B in a state in which the second middle yoke 21B is inserted into the air-core portion 19B.

As shown in FIG. 2 as an example, the first VCM 13A and the second VCM 13B are disposed such that an angle viewed from the center side of the lens 5 is a right angle (in an example shown in FIG. 2, 90 degrees). The first VCM 13A and the second VCM 13B are disposed in this way, whereby the holding frame 10 moves in a radial direction (hereinafter, also referred to as a “lens radial direction”) of the lens 5 within a plan intersecting the optical axis OA of the lens 5 by receiving power generated by the first VCM 13A and/or the second VCM 13B.

In the first VCM 13A, a current is applied to the first coil 18A. The first coil 18A generates thrust from the applied current and magnetic flux. The magnetic flux contributing to thrust generation in the first coil 18A includes magnetic flux generated from the first coil 18A by application of a current and magnetic flux generated from the first upper magnet 25A and the first lower magnet 26A, and thrust is generated from such magnetic flux. The first coil 18A moves the holding frame 10 in a Y-direction (hereinafter, simply referred to as a “Y-direction”) shown in FIG. 2 by giving the generated thrust to the holding frame 10. The Y-direction is perpendicular to the optical axis OA. The “Y-direction” described herein is an example of a “lens radial direction” according to the technique of the present disclosure.

In the second VCM 13B, a current is applied to the second coil 18B. The second coil 18B generates thrust from the applied current and magnetic flux. The magnetic flux contributing to thrust generation in the second coil 18B includes magnetic flux generated from the second coil 18B by the application of the current and magnetic flux generated from the second upper magnet 25B and the second lower magnet 26B, and thrust is generated from such magnetic flux. The second coil 18B moves the holding frame 10 in an X-direction (hereinafter, simply referred to as an “X-direction”) shown in FIG. 2 by giving the generated thrust to the holding frame 10. The X-direction is a direction that is perpendicular to the optical axis OA and is also perpendicular to the Y-direction. The “X-direction” described herein is an example of the lens radial direction according to the technique of the present disclosure.

Next, the size of the first upper yoke 20A in the lens radial direction will be described. As shown in FIG. 3 as an example, at the lens initial position, the end surface 36A of the first upper yoke 20A on the lens 5 side is positioned on a side closer to the optical axis OA by a distance L1 than an end surface 37A of the first coil 18A on the lens 5 side. The end surface 37A is a surface of the first coil 18A on the lens 5 most side.

Similarly to the first upper yoke 20A, an end surface 46A of the first lower yoke 22A on the lens 5 side is positioned on a side closer to the optical axis OA by the distance L1 than the end surface 37A.

The distance L1 indicates a distance equal to or longer than a distance at which the holding frame 10 in a state in which the lens 5 is disposed at the lens initial position is movable to the maximum in a direction of being separated from the first VCM magnet section 30A. That is, even in a case where the first coil 18A is moved to the maximum in the direction of being separated from the first VCM magnet section 30A, the end surface 37A is not moved to the optical axis OA side with respect to the end surface 36A and the end surface 46A. That is, the end surface 36A and the end surface 46A are positioned on a side closer to the optical axis OA than an end point on the lens 5 side in the movable range of the first coil 18A.

Next, the size of the second upper yoke 20B in the lens radial direction will be described. As shown in FIG. 4 as an example, at the lens initial position, an end surface 36B of the second upper yoke 20B on the lens 5 side is positioned on a side closer to the optical axis OA by a distance L2 than an end surface 37B of the second coil 18B on the lens 5 side. The end surface 37B is a surface of the second coil 18B on the lens 5 most side.

Similarly to the second upper yoke 20B, an end surface 46B of the second lower yoke 22B on the lens 5 side is positioned on a side closer to the optical axis OA by the distance L2 than the end surface 37B.

The distance L2 indicates a distance equal to or longer than a distance at which the holding frame 10 in a state in which the lens 5 is disposed at the lens initial position is movable to the maximum in a direction of being separated from the second VCM magnet section 30B. That is, even in a case where the second coil 18B is moved to the maximum in the direction of being separated from the second VCM magnet section 30B, the end surface 37B is not moved to the optical axis OA side with respect to the end surface 36B and the end surface 46B. That is, the end surface 36B and the end surface 46B are positioned on a side closer to the optical axis OA than an end point on the lens 5 in the movable range of the second coil 18B. In the first embodiment, L1=L2.

Next, the configuration of the first middle yoke 21A will be described. As shown in FIG. 5 as an example, the first middle yoke 21A has a recess 51A1. A side surface 51A of the first middle yoke 21A facing the outer peripheral surface of the lens 5 is an example of a “recess (recess portion)” according to the technique of the present disclosure. The side surface 51A is formed as the recess 51A1. Specifically, the side surface 51A is formed in a shape recessed in a direction of being separated from the optical axis OA to be thus formed as the recess 51A1. The side surface 51A is recessed along the outer peripheral shape of the holding frame 10. In the first embodiment, the entire surface of the side surface 51A is formed in a recessed shape. Note that the shape of the side surface 51A is not limited thereto. For example, the side surface 51A may be formed in a partially recessed shape.

The expression “facing the outer peripheral surface of the lens 5” can be replaced with “facing an outer peripheral surface 10A of the holding frame 10 that holds the lens 5”. This is because, in a case where the outer peripheral surface of the lens 5 of a portion that the side surface 51A faces is not held by the holding frame 10, the side surface 51A directly faces the outer peripheral surface of the lens 5; however, in a case where the outer peripheral surface of the lens 5 of the portion that the side surface 51A faces is held by the holding frame 10, the side surface 51A directly faces the holding frame 10.

In the first embodiment, the shape of the outer periphery of the holding frame 10 is a ring shape, and the side surface 51A is recessed in an arc shape complementary to the outer peripheral surface 10A of the facing holding frame 10. Here, although the ring shape has been exemplified as the shape of the outer periphery of the holding frame 10, the technique of the present disclosure is not limited thereto, and the shape of the outer periphery of the holding frame 10 may be an arc shape. The term “complementary” in the specification refers to a case where one portion is a protrusion and the other portion is a recess. The protrusion and the recess do not need to have shapes of being closely fitted.

As shown in FIG. 5 as an example, the side surface 51A of the first middle yoke 21A has two protruding end portions 35A. The two protruding end portions 35A are both end portions of the recess 51A1 in the tangential direction of the outer periphery of the lens 5. The tangential direction of the outer periphery of the lens 5 is the width direction.

The two protruding end portions 35A protrude from the first coil 18A toward the outer peripheral surface of the lens 5 at a first coil initial position. The “first coil initial position” described herein indicates a position of the first coil 18A in a state in which the lens 5 is not subjected to movement control for shake correction.

Here, although a form example where the two protruding end portions 35A protrude from the first coil 18A toward the outer peripheral surface of the lens 5 at the first coil initial position has been exemplified, the technique of the present disclosure is not limited thereto. Even though the first coil 18A is at a position other than the first coil initial position, the two protruding end portions 35A may protrude from the first coil 18A toward the outer peripheral surface of the lens 5.

Here, although a form example where the protruding end portions 35A are formed in both end portions of the side surface 51A has been exemplified, the technique of the present disclosure is not limited thereto. The protruding end portion 35A may be formed only in one end portion of the side surface 51A.

In the first embodiment, the two protruding end portions 35A protrude from the first coil 18A toward the outer peripheral surface of the lens 5 even within the movable range of the first coil 18A.

Next, the configuration of the second middle yoke 21B will be described. As shown in FIG. 5 as an example, the second middle yoke 21B has a recess 51B1. A side surface 51B of the second middle yoke 21B facing the outer peripheral surface of the lens 5 is an example of a “recess (recess portion)” according to the technique of the present disclosure. The side surface 51B is formed as the recess 51B1. Specifically, the side surface 51B is formed in a shape recessed in a direction of being separated from the optical axis OA, whereby the side surface 51B is formed as the recess 51B1. The side surface 51B is recessed along the outer peripheral shape of the holding frame 10. In the first embodiment, the entire side surface 51B is formed in a recessed shape. Note that the shape of the side surface 51B is not limited thereto. For example, the side surface 51B may be formed in a partially recessed shape.

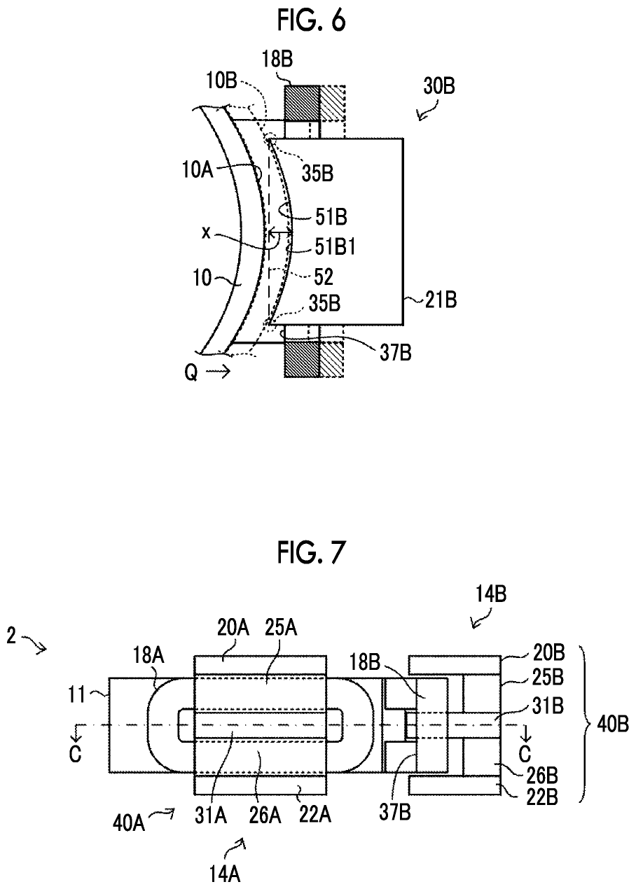

As shown in FIG. 6 as an example, in a case where the holding frame 10 is moved in a direction of an arrow Q, that is, in a direction of the second middle yoke 21B, the holding frame 10 shown by a solid line is moved to a position shown by a dotted line. In a case where the shape of the second middle yoke 21B is a rectangular parallelepiped shape, since the holding frame 10 collides with a virtual side surface 52 inside the second middle yoke 21B, movement in the direction of the arrow Q is restricted. Note that, in the second middle yoke 21B according to the first embodiment, since the side surface 51B is formed as the recess 51B1, the holding frame 10, that is, the lens 5 is made to approach the second middle yoke 21B by a distance×compared to a case where the second middle yoke 21B is a rectangular parallelepiped. The same can apply to the first VCM 13A.

As shown in FIG. 5 as an example, the side surface 51B of the second middle yoke 21B has two protruding end portions 35B. The two protruding end portions 35B are both end portions of the recess 51B1 in the tangential direction of the outer periphery of the lens 5.

The two protruding end portions 35B protrude from the second coil 18B toward the outer peripheral surface of the lens 5 at a second coil initial position. The “second coil initial position” indicates a position of the second coil 18B in a state in which the lens is not subjected to movement control for shake correction.

Here, although a form example where the two protruding end portions 35B protrude from the second coil 18B toward the outer peripheral surface of the lens 5 at the second coil initial position has been exemplified, the technique of the present disclosure is not limited. Even though the second coil 18B is at a position other than the second coil initial position, the two protruding end portions 35B may protrude from the second coil 18B toward the outer peripheral surface of the lens 5.

Here, although a form example where the protruding end portions 35B are formed in both end portions of the side surface 51B has been exemplified, the technique of the present disclosure is not limited. The protruding end portion 35B may be formed only in one end portion of the side surface 51B.

In the first embodiment, the two protruding end portions 35B protrude from the second coil 18B toward the outer peripheral surface of the lens 5 even within the movable range of the second coil 18B.

The lens drive device 1 that includes the first VCM 13A and the second VCM 13B having the above-described configurations can correct shake by moving the lens 5 in the radial direction of the lens 5 along with the holding frame 10.

With the configuration of the lens drive device 1 according to the first embodiment described above, it is possible to make the lens 5 approach the first middle yoke 21A at the lens initial position compared to a case where the side surface 51A of the first middle yoke 21A of the first VCM 13A facing the outer peripheral surface of the lens 5 is an unrecessed flat surface. For this reason, it is possible to achieve reduction in size of the lens drive device 1 compared to a case where the side surface of the first middle yoke 21A is not recessed.

The two protruding end portions 35A of the side surface 51A of the first middle yoke 21A are formed in both end portions of the side surface 51A in the tangential direction of the outer periphery of the lens 5. Both the two protruding end portions 35A protrude from the first coil 18A toward the outer peripheral surface of the lens 5 at the first coil initial position of the first coil 18A. With such a configuration, in a case where the first coil 18A is separated from the first middle yoke 21A, it is possible to suppress a decrease in overlapping area of the first middle yoke 21A and the first coil 18A in the direction along the optical axis OA, compared to a case where both the protruding end portions 35A of the side surface 51A do not protrude from the first coil 18A toward the outer peripheral surface of the lens 5. Accordingly, in a case where the first coil 18A is separated from the first middle yoke 21A, it is possible to suppress change in thrust of the first coil 18A, compared to a case where a decrease in overlapping area of the first middle yoke 21A and the first coil 18A in the direction along the optical axis OA is not suppressed. A configuration may be made in which any one of the two protruding end portions 35A has the above-described characteristic.

The protruding end portions 35A protrude from the first coil 18A toward the outer peripheral surface of the lens 5 within the movable range of the first coil 18A. With this configuration, even though the holding frame 10 is moved to any position, it is possible to suppress fluctuation of the thrust of the first VCM 13A. This is because, even though the holding frame 10 is moved to any position, most of the first coil 18A is present within the range of the magnetic flux formed by the first VCM magnet section 30A.

The side surface 51A is recessed along the outer peripheral shape of the holding frame 10. With this configuration, it is possible to make the first middle yoke 21A and the lens 5 approach each other, compared to a case where the side surface 51A of the first middle yoke 21A facing the outer peripheral surface of the lens 5 is not recessed in the direction of being separated from the optical axis OA, for example, a linear flat surface.

The shape of the outer periphery of the holding frame 10 is an arc shape, and the side surface 51A is recessed in an arc shape complementary to the arc-shaped outer peripheral surface 10A of the facing holding frame 10. With this configuration, it is possible to make the first middle yoke 21A and the holding frame 10 further approach each other, compared to a case where the shape of the outer periphery of the holding frame 10 is a ring shape, and the side surface 51A has a non-arc shape.

The first upper magnet 25A and the first lower magnet 26A are disposed such that identical magnetic poles face each other while sandwiching the first middle yoke 21A. With this configuration, it is possible to increase magnetic flux density in each yoke, compared to a case where the first upper magnet 25A and the first lower magnet 26A are disposed such that different magnetic poles face each other while sandwiching the first middle yoke 21A.

The end surface 36A of the first upper yoke 20A and the end surface 46A of the first lower yoke 22A are positioned on a side closer to the optical axis OA than the end point on the lens 5 side in the movable range of the first coil 18A. With this configuration, since an overlapping region of the magnetic flux of the first upper magnet 25A and the first lower magnet 26A and the magnetic flux of the first coil 18A in the movable range of the first coil 18A increases compared to a case where the end surface 36A and the end surface 46A are present on a side farther from the optical axis than the end point, it is possible to generate large thrust. For the same reason, it is possible to decrease change in thrust depending on the position of the holding frame 10 in the movable range of the first coil 18A.

The configurations of the second VCM 13B and the second coil 18B are the same as the above-described configuration, and accordingly, the same effects are obtained.

(Modification Example 1)

In the above-described first embodiment, the number of voice coil motors is two. Note that the number of voice coil motors is not limited. For example, the number of voice coil motors may be three or four. To decrease the size of the lens drive device 1, it is preferable that the number of voice coil motors is two.

(Modification Example 2)

In the above-described first embodiment, the first VCM magnet section 30A has a configuration in which the first upper yoke 20A, the first upper magnet 25A, the first middle yoke 21A, the first lower magnet 26A, and the first lower yoke 22A are laminated. Note that the first VCM magnet section 30A may be configured by laminating any one of the first middle yoke 21A, the first upper magnet 25A, or the first lower magnet 26A. The configuration of the first middle yoke 21A is as described in the first embodiment. The same modification example is applicable to the second VCM magnet section 30B.

### Second Embodiment

Next, a lens drive device 2 according to a second embodiment will be described referring to the drawings. The same constituent elements as those in the lens drive device 1 of the first embodiment are represented by the same reference numerals, and description thereof will not be repeated.

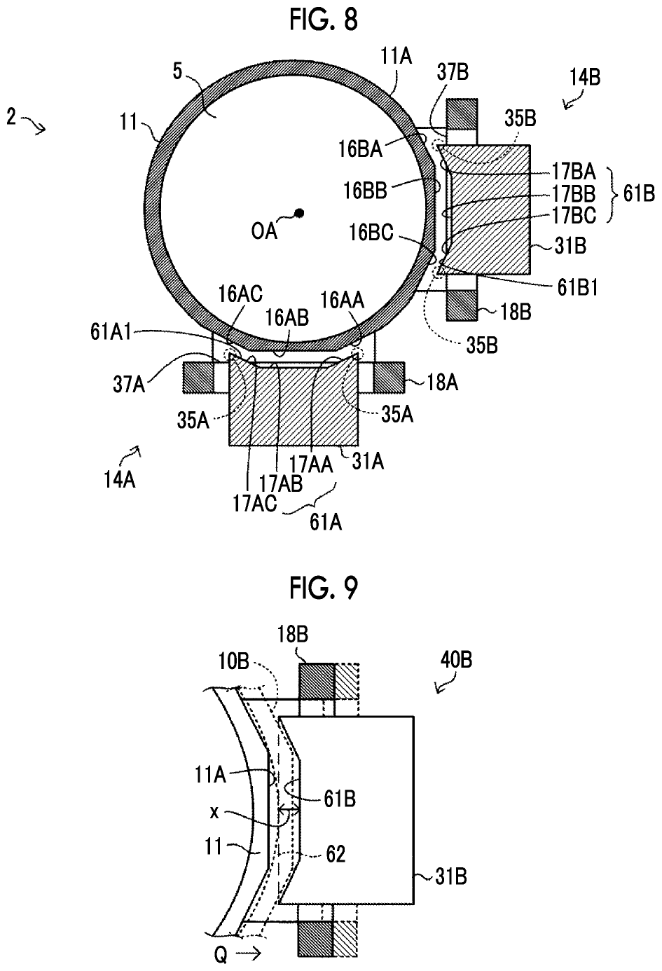

As shown in FIGS. 7 and 8 as an example, the lens drive device 2 has a holding frame 11 that holds the lens 5, a first VCM 14A, and a second VCM 14B.

The first VCM 14A includes a first VCM magnet section 40A and a first coil 18A. The first VCM magnet section 40A includes a first upper yoke 20A, a first upper magnet 25A, a first middle yoke 31A, a first lower magnet 26A, and a first lower yoke 22A. The first upper yoke 20A, the first upper magnet 25A, the first lower magnet 26A, and the first lower yoke 22A in the first VCM magnet section 40A, and the first coil 18A are the same as the corresponding elements of the lens drive device 1.

The second VCM 14B includes a second VCM magnet section 40B and a second coil 18B. The second VCM magnet section 40B includes a second upper yoke 20B, a second upper magnet 25B, a second middle yoke 31B, a second lower magnet 26B, and a second lower yoke 22B. The second upper yoke 20B, the second upper magnet 25B, the second lower magnet 26B, and the second lower yoke 22B in the second VCM magnet section 40B, and the second coil 18B are the same as the corresponding elements of the lens drive device 1.

The first VCM magnet section 40A and the second VCM magnet section 40B are fixed to the housing 100. The first coil 18A and the second coil 18B are fixed to the holding frame 11.

As shown in FIG. 8 as an example, the first middle yoke 31A has a recess 61A1. A side surface 61A of the first middle yoke 31A facing the outer peripheral surface of the lens 5 is an example of a “recess (recess portion)” according to the technique of the present disclosure. The side surface 61A is formed in a shape recessed in the direction of being separated from the optical axis OA to be thus formed as the recess 61A1.

Specifically, a part of an outer peripheral surface 11A of the holding frame 11 is configured with three planes 16AA, 16AB, and 16AC cut planarly. The side surface 61A is formed in a recessed shape configured with three planes 17AA, 17AB, and 17AC complementary to the shape formed by the three planes 16AA, 16AB, 16AC.

The second middle yoke 31B of the second VCM 14B has a recess 61B1. A side surface 61B of the first middle yoke 31B facing the outer peripheral surface of the lens 5 is an example of a “recess (recess portion)” according to the technique of the present disclosure. The side surface 61B is formed in a shape recessed in the direction of being separated from the optical axis OA to be thus formed as the recess 61B1.

Specifically, a part of the outer peripheral surface 11A of the holding frame 11 is configured with three planes 16BA, 16BB, and 16BC cut planarly. The side surface 61B is formed in a recessed shape configured with three planes 17BA, 17BB, and 17BC complementary to the shape formed by the three planes 16BA, 16BB, and 16BC.

As shown in FIG. 9 as an example, in a case where the holding frame 11 is moved in a direction of an arrow Q, that is, a direction of the second middle yoke 31B, the holding frame 11 shown by a solid line is moved to a position shown by a dotted line. In a case where the shape of the second middle yoke 31B is a rectangular parallelepiped shape, since the holding frame 11 collides with a virtual side surface 62 inside the second middle yoke 31B, movement in the direction of the arrow Q is restricted. Note that, in the second middle yoke 31B according to the second embodiment, since the side surface 61B is formed as the recess 61B1, it is possible to make the holding frame 11, that is, the lens 5 approach the second middle yoke 31B by a distance x, compared to a case where the second middle yoke 31B is a rectangular parallelepiped. The same can apply to the first VCM 14A.

As shown in FIG. 8 as an example, the side surface 61A of the first middle yoke 31A has two protruding end portions 35A. The two protruding end portions 35A are both end portions of the recess 61A1 in a tangential direction of the outer periphery of the lens 5. The two protruding end portions 35A protrude from the first coil 18A toward the outer peripheral surface of the lens 5 at a first coil initial position.

In the second embodiment, although a form example where the two protruding end portions 35A protrude from the first coil 18A toward the outer peripheral surface of the lens 5 at the first coil initial position has been exemplified, the technique of the present disclosure is not limited. Even though the first coil 18A is at a position other than the first coil initial position, the two protruding end portions 35A may protrude from the first coil 18A toward the outer peripheral surface of the lens 5. Here, although a form example where the protruding end portions 35A are formed in both end portions of the side surface 61A has been exemplified, the technique of the present disclosure is not limited. The protruding end portion 35A may be formed only in one end portion of the side surface 61A. In the second embodiment, the two protruding end portions 35A protrude from the first coil 18A toward the outer peripheral surface of the lens 5 even within the movable range of the first coil 18A.

Similarly, as shown in FIG. 8 as an example, the side surface 61B of the second middle yoke 31B has two protruding end portions 35B. The two protruding end portions 35B are both end portions of the recess 61B1 in the tangential direction of the outer periphery of the lens 5. The two protruding end portions 35A protrude from the second coil 18B toward the outer peripheral surface of the lens 5 at a second coil initial position.

In the second embodiment, although a form example where the two protruding end portions 35B protrude from the second coil 18B toward the outer peripheral surface of the lens 5 at a second coil initial position has been exemplified, the technique of the present disclosure is not limited. Even though the second coil 18B is at a position other than the second coil initial position, the two protruding end portions 35B may protrude from the second coil 18B toward the outer peripheral surface of the lens 5. Here, although a form example where the protruding end portions 35B are formed in both end portions of the side surface 61B has been exemplified, the technique of the present disclosure is not limited. The protruding end portion 35B may be formed only in one end portion of the side surface 61B. In the second embodiment, the two protruding end portions 35B protrude from the second coil 18B toward the outer peripheral surface of the lens 5 even within the movable range of the second coil 18B.

With the configuration of the lens drive device 2 according to the second embodiment described above, the same effects as the lens drive device 1 according to the first embodiment are obtained. The modification examples that are applicable in the first embodiment are also applicable in the second embodiment.

### Third Embodiment

Next, a lens drive device 3 according to a third embodiment will be described referring to the drawings. The same constituent elements as those in the lens drive device 1 of the first embodiment are represented by the same reference numerals, and description thereof will not be repeated.

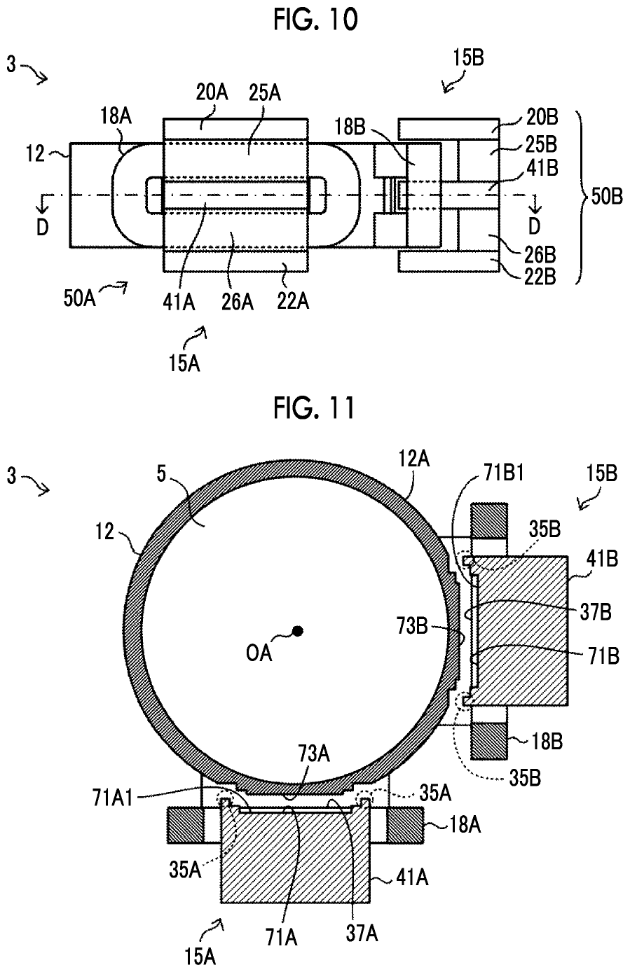

As shown in FIGS. 10 and 11 as an example, the lens drive device 3 has a holding frame 12 that holds the lens 5, a first VCM 15A, and a second VCM 15B.

The first VCM 15A includes a first VCM magnet section 50A and a first coil 18A. The first VCM magnet section 50A includes a first upper yoke 20A, a first upper magnet 25A, a first middle yoke 41A, a first lower magnet 26A, and a first lower yoke 22A. The first upper yoke 20A, the first upper magnet 25A, the first lower magnet 26A, and the first lower yoke 22A in the first VCM magnet section 50A, and the first coil 18A are the same as the corresponding elements of the lens drive device 1.

The second VCM 15B includes a second VCM magnet section 50B and a second coil 18B. The second VCM magnet section 50B includes a second upper yoke 20B, a second upper magnet 25B, a second middle yoke 41B, a second lower magnet 26B, and a second lower yoke 22B. The second upper yoke 20B, the second upper magnet 25B, the second lower magnet 26B, and the second lower yoke 22B in the second VCM magnet section 50B, and the second coil 18B are the same as the corresponding elements of the lens drive device 1.

The first VCM magnet section 50A and the second VCM magnet section 50B are fixed to the housing 100. The first coil 18A and the second coil 18B are fixed to the holding frame 12.

As shown in FIG. 11 as an example, the first middle yoke 41A has a recess 71A1. A side surface 71A of the first middle yoke 41A facing the outer peripheral surface of the lens 5 is an example of a “recess (recess portion)” according to the technique of the present disclosure. The side surface 71A is formed as the recess 71A1. Specifically, the side surface 71A is formed in a shape recessed in the direction of being separated from the optical axis OA to be thus formed as the recess 71A1. The side surface 71A is recessed along an outer peripheral shape of the holding frame 12. Specifically, an outer peripheral surface 12A of the holding frame 12 has a protrusion 73A configured in a stepped shape. The side surface 71A is formed as the recess 71A1 complementary to the protrusion 73A.

Similarly, as shown in FIG. 11 as an example, the second middle yoke 41B has a recess 71B1. A side surface 71B of the second middle yoke 41B facing the outer peripheral surface of the lens 5 is an example of a “recess (recess portion)” according to the technique of the present disclosure. The side surface 71B is formed as the recess 71B1. Specifically, the side surface 71B is formed in a shape recessed in the direction of being separated from the optical axis OA to be thus formed as the recess 71B1. The side surface 71B is recessed along the outer peripheral shape of the holding frame 12. Specifically, the outer peripheral surface 12A of the holding frame 12 has a protrusion 73B configured in a stepped shape. The side surface 71B is formed as the recess 71B1 complementary to the protrusion 73B.

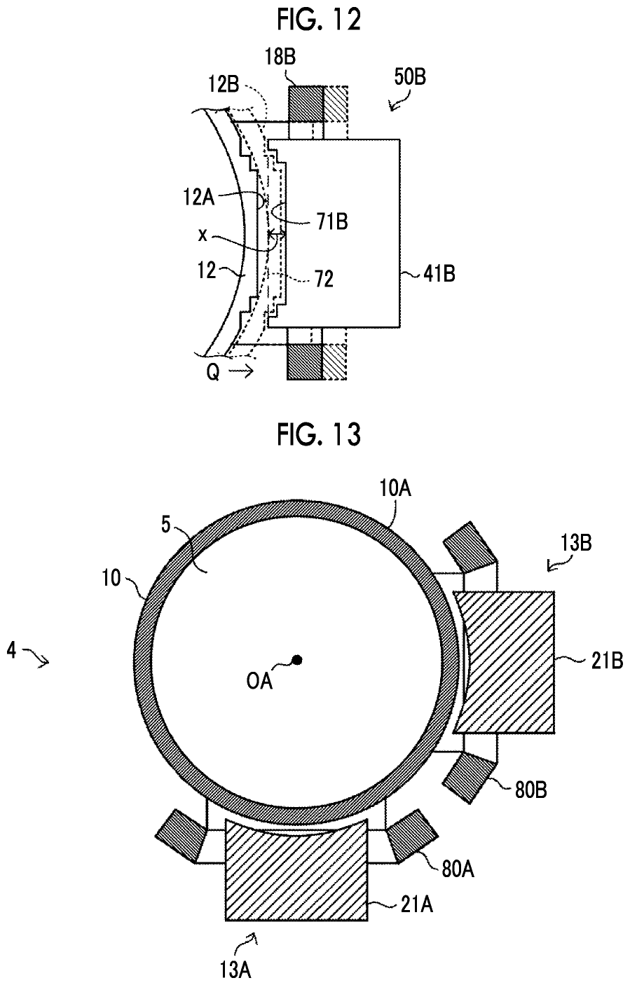

As shown in FIG. 12 as an example, in a case where the holding frame 12 is moved in a direction of an arrow Q, that is, in a direction of the second middle yoke 41B, the holding frame 12 shown by a solid line is moved to a position shown by a dotted line. In a case where the shape of the second middle yoke 41B is a rectangular parallelepiped shape, since the holding frame 12 collides with a virtual side surface 72 inside the second middle yoke 41B, movement in the direction of the arrow Q is restricted. Note that, in the second middle yoke 41B according to the third embodiment, since the side surface 71B is formed as the recess 71B1, it is possible to make the holding frame 12, that is, the lens 5 approach the second middle yoke 41B by a distance x, compared to a case where the second middle yoke 41B is a rectangular parallelepiped. The same can apply to the first VCM 15A.

As shown in FIG. 11 as an example, the side surface 71A of the first middle yoke 41A has two protruding end portions 35A. The two protruding end portions 35A are both end portions of the recess 71A1 in the tangential direction of the outer periphery of the lens 5. The two protruding end portions 35A protrude from the first coil 18A toward the outer peripheral surface of the lens 5 at a first coil initial position.

In the third embodiment, although a form example where the two protruding end portions 35A protrude from the first coil 18A toward the outer peripheral surface of the lens 5 at the first coil initial position has been exemplified, the technique of the present disclosure is not limited. Even though the first coil 18A is at a position other than the first coil initial position, the two protruding end portions 35A may protrude from the first coil 18A toward the outer peripheral surface of the lens 5. Here, although a form example where the protruding end portions 35A are formed in both end portions of the side surface 71A has been exemplified, the technique of the present disclosure is not limited. The protruding end portion 35A may be formed only in one end portion of the side surface 71A. In the third embodiment, the two protruding end portions 35A protrude from the first coil 18A toward the outer peripheral surface of the lens 5 even within the movable range of the first coil 18A.

Similarly, as shown in FIG. 11 as an example, the side surface 71B of the second middle yoke 41B has two protruding end portions 35B. The two protruding end portions 35B are both end portions of the recess 71B1 in the tangential direction of the outer periphery of the lens 5. The two protruding end portions 35A protrude from the second coil 18B toward the outer peripheral surface of the lens 5 at a second coil initial position.

In the third embodiment, although a form example where the two protruding end portions 35B protrude from the second coil 18B toward the outer peripheral surface of the lens 5 at the second coil initial position has been exemplified, the technique of the present disclosure is not limited. Even though the second coil 18B is at a position other than the second coil initial position, the two protruding end portions 35B may protrude from the second coil 18B toward the outer peripheral surface of the lens 5. Here, although a form example where the protruding end portions 35B are formed in both end portions of the side surface 71B has been exemplified, the technique of the present disclosure is not limited. The protruding end portion 35B may be formed only in one end portion of the side surface 71B. In the third embodiment, the two protruding end portions 35B protrude from the second coil 18B toward the outer peripheral surface of the lens 5 even within the movable range of the second coil 18B.

With the configuration of the lens drive device 3 according to the third embodiment described above, the same effects as the lens drive device 1 according to the first embodiment are obtained. The modification examples that are applicable in the first embodiment are also applicable in the third embodiment.

### Fourth Embodiment

Next, a lens drive device 4 according to a fourth embodiment will be described referring to the drawings. As shown in FIG. 13 as an example, the lens drive device 4 is configured such that shapes of a first coil 80A and a second coil 80B are different from the shapes of the first coil 18A and the second coil 18B shown in the first embodiment. Other configurations are the same as those in the lens drive device 1 described in the first embodiment.

As shown in FIG. 13, the first coil 80A and the second coil 80B of the lens drive device 4 are formed by being bent along the outer peripheral shape of the holding frame 10. In particular, at least one end portion of both end portions of the first coil 80A and the second coil 80B in the tangential direction of the outer periphery of the lens 5 is formed by being bent along the outer peripheral shape of the holding frame 10. The concept of being bent along the outer peripheral shape includes, for example, a concept of being bent in a direction approaching the optical axis OA. In the fourth embodiment, both end portions of the first coil 80A and the second coil 80B are formed by being bent.

To increase the thrust of the voice coil motor, it is effective to extend the length of the coil in the longitudinal direction. Note that, in a case where the coil is extended, there is a need to increase the size of the lens drive device to prevent both end portions of the coil from interfering with the housing. With the above-described configuration, compared to a case where the first coil 80A and the second coil 80B are not bent along the outer peripheral shape of the lens 5, it is possible to decrease a distance between the center of the lens 5 and the outermost portions of the first coil 80A and the second coil 80B. Accordingly, it is possible to achieve reduction in diameter of the lens drive device 4.

Both end portions of the first coil 80A and the second coil 80B in the tangential direction of the outer periphery of the lens 5 are portions not contributing to generation of thrust for driving the holding frame 10 since winding wires are wound in the direction along the optical axis OA. Therefore, even though both end portions are bent in a direction approaching the holding frame 10, the thrust of the lens drive device 4 is not decreased compared to a case where both end portions are not bent.

### Fifth Embodiment

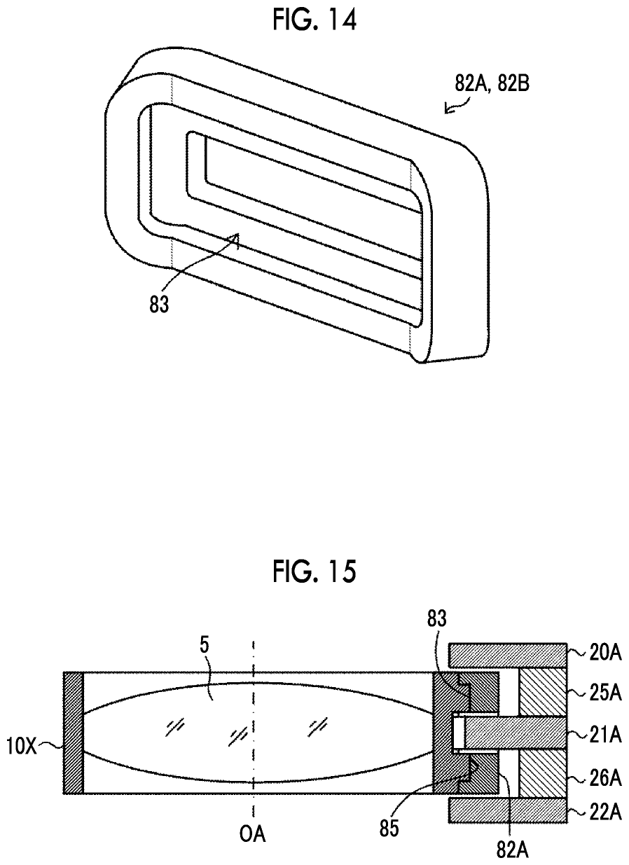

Next, a first coil 82A and a second coil 82B (hereinafter, referred to as “coils 82A and 82B”) according to a fifth embodiment will be described referring to the drawings. As shown in FIGS. 14 and 15 as an example, each of the coils 82A and 82B has a receiving recess 83 that receives an outer peripheral portion of a holding frame 10X. The receiving recess 83 is an example of a “dent” according to the technique of the present disclosure. As shown in FIG. 14, the coils 82A and 82B are configured such that both end portions in the tangential direction of the outer periphery of the lens 5 are formed by being bent along the outer peripheral shape of the holding frame 10X as shown in the fourth embodiment.

As shown in FIG. 15, the outer peripheral surface of the holding frame 10X to which the coils 82A and 82B are attached have protrusions 85 that are received in the receiving recesses 83. The receiving recess 83 of the coils 82A and 82B is formed in a recessed shape conforming to the protrusions 85. Other configurations are the same as those in the lens drive device 1 described in the first embodiment.

The receiving recesses 83 are provided, whereby attachment of the coils 82A and 82B to the holding frame 10X is facilitated, compared to a case where the receiving recesses 83 are not provided. Although the coils 82A and 82B are disposed at an interval of 90°, the holding frame 10X has the protrusions 85 disposed at an interval of 90°, and thus, positioning of the coils 82A and 82B is facilitated. The coils 82A and 82B can be closely attached to the holding frame 10X. For this reason, it is possible to achieve further reduction in size of the lens drive device, compared to a case where the receiving recesses 83 are not provided.

In all the embodiments described above, the coil is fixed to the holding frame of the lens 5, and the magnet section is fixed to the housing 100. Note that the coil may be fixed to the housing, and the magnet section may be fixed to the holding frame. Since the magnet section is greater in size and weight than the coil, there is a need to increase the thrust of the holding frame in a case of fixing the magnet section to the holding frame, and the size of a drive section increases. Accordingly, it is preferable that the coil is fixed to the holding frame of the lens 5, and the magnet section is fixed to the housing, from a viewpoint of reduction in size of the lens drive device.

The lens drive device according to each embodiment described above is applicable to, for example, an imaging device, such as a digital camera and a digital video camera, and an imaging module mounted in an electronic endoscope, a mobile phone equipped with a camera, and the like.

In the specification, “A and/or B” is synonymous with “at least one of” A or B. That is, “A and/or B” may refer to A alone, B alone, or a combination of A and B. Furthermore, in the specification, a similar concept to “A and/or B” applies to a case in which three or more matters are expressed by linking the matters with “and/or”.

All cited documents, patent applications, and technical standards described in the specification are incorporated by reference in the specification to the same extent as in a case where each individual cited document, patent application, or technical standard is specifically and individually indicated to be incorporated by reference.

What is claimed is:

1. A lens drive device comprising:
a holder that holds a lens for shake correction from an outer peripheral side of the lens; and
a plurality of coil motors that are disposed along a circumferential direction of the lens with respect to the holder,
wherein each of the coil motors includes a magnet, a yoke that forms magnetic flux along with the magnet, and a coil that has an air-core portion, the coil being fixed to the holder, the yoke being inserted into the air-core portion, and the coil being configured to move the holder in a lens radial direction by generating thrust from an applied current and the magnetic flux,
the yoke has a dent in which a side surface of the yoke facing an outer peripheral surface of the lens is formed in a shape recessed in a direction of being separated from an optical axis of the lens; and
a direction in which the yoke being inserted into the air-core portion is a direction perpendicular to the optical axis.

2. The lens drive device according to claim 1,
wherein a protruding end portion of the dent protrudes from the coil toward the outer peripheral surface.

3. The lens drive device according to claim 2,
wherein the protruding end portion protrudes from the coil toward the outer peripheral surface at an initial position of the coil.

4. The lens drive device according to claim 2,
wherein the protruding end portion protrudes from the coil toward the outer peripheral surface within a movable range of the coil.

5. The lens drive device according to claim 2,
wherein the protruding end portion is both end portions of the dent in a tangential direction of an outer periphery of the lens.

6. The lens drive device according to claim 1,
wherein the dent is recessed along an outer peripheral shape of the holder.

7. The lens drive device according to claim 6,
wherein the outer peripheral shape is a ring shape or an arc shape, and the dent is recessed in an arc shape.

8. The lens drive device according to claim 1,
wherein the magnet has a first magnet that is provided on a first direction side of the yoke along the optical axis, and a second magnet that is provided on a second direction side of the yoke opposite to the first direction, and
the first magnet and the second magnet are disposed such that identical magnetic poles face each other while sandwiching the yoke.

9. The lens drive device according to claim 8, further comprising:
a first direction-side yoke that is provided on the first direction side of the first magnet; and
a second direction-side yoke that is provided on the second direction side of the second magnet,
wherein an end surface of the first direction-side yoke on the lens side and an end surface of the second direction-side yoke on the lens side are positioned on a side closer to the optical axis than an end point on the lens side in a movable range of the coil.

10. The lens drive device according to claim 1,
wherein the coil is formed by being bent along an outer peripheral shape of the holder.

11. The lens drive device according to claim 10,
wherein at least one end portion of both end portions of the coil in a tangential direction of the outer periphery of the lens is formed by being bent along an outer peripheral shape of the holder.

12. The lens drive device according to claim 11,
wherein at least one end portion of both end portions of the coil is formed by being bent in a direction approaching the optical axis.

13. The lens drive device according to claim 1,
wherein the magnet and the yoke are fixed to a housing, the coil is fixed to the holder, and the holder is movably supported by the housing.

14. The lens drive device according to claim 1,
wherein the coil has a receiving recess that receives an outer peripheral portion of the holder.

15. The lens drive device according to claim 3,
wherein the protruding end portion protrudes from the coil toward the outer peripheral surface within a movable range of the coil.

16. The lens drive device according to claim 3,
wherein the protruding end portion is both end portions of the dent in a tangential direction of an outer periphery of the lens.

17. The lens drive device according to claim 4,
wherein the protruding end portion is both end portions of the dent in a tangential direction of an outer periphery of the lens.

18. The lens drive device according to claim 2,
wherein the dent is recessed along an outer peripheral shape of the holder.

19. The lens drive device according to claim 3,
wherein the dent is recessed along an outer peripheral shape of the holder.

20. The lens drive device according to claim 4,
wherein the dent is recessed along an outer peripheral shape of the holder.
